(19) United States
(12) Patent Application Publication
(10) Pub. No.: US 2004/0145642 A1
(43) Pub. Date: Jul. 29, 2004

(54) Liquid jetting apparatus

(76) Inventors: Yoshihide Hoshino, Tokyo (JP); Koji Matsushima, Tokyo (JP)

Correspondence Address: CANTOR COLBURN LLP, 55 Griffin Road South, Bloomfield, CT, 06002, US

(21) Appl. No.: 10/750,704

(22) Filed: Jan. 2, 2004

(30) Foreign Application Priority Data
Jan. 17, 2003 (JP) 2003-009049

(51) Int. Cl. B41J 2/01

(52) U.S. Cl. 347/102

(57) ABSTRACT

A liquid jetting apparatus having: a head for jetting a liquid of photo curable type which is cured by an irradiation with light; a light source for irradiating the liquid of photo curable type jetted on an object from the head; at least one of a temperature sensor for detecting a temperature adjacent to the object, and a humidity sensor for detecting a humidity adjacent to the object; and a control section for controlling an illumination of light which is radiated from the light source, wherein the control section controls the illumination on the basis of a result detected by at least one of the temperature sensor and the humidity sensor.

### BACKGROUND OF THE INVENTION

1. Field of the Invention

The present invention relates to a liquid jetting apparatus and, more particularly, to a liquid jetting apparatus which irradiates liquid of photo curable type jetted on an object with light to cure the liquid.

2. Description of the Related Art

Earlier, various types of printing methods have been developed and established, such as a relief printing in which ink placed on convexities of a plate having convexoconcave is transferred to a recording medium, or an intaglio printing which is reverse to the relief printing, in which ink is stored in concaves of a plate, and the plate is pressed to a recording medium to transfer the ink to the recording medium. The relief printing and the intaglio printing have an advantage that once a plate is produced, a large lot printing can be realized so as to reduce the printing cost per printing significantly. However, it requires a lot of time and costs a lot in printing process for a small lot printing. Recently, an ink jet recording method in which printings can be produced easily and at a low price in comparison to the relief printing or the intaglio printing has been applied to various printing fields of a special printing or the like such as a photograph, various types of printings, marking, color filter.

As the above ink jet recording method, a phase change ink jet method in which wax ink which is solid in room temperature is used, a solvent system ink jet method in which ink whose main component is quick-drying organic solvent is used, a photo curable type ink jet method in which ink which is cured by ultraviolet rays irradiation is used or the like has been put into practical use. Specially, the photo curable type ink jet method emits relatively low odor in comparison to the other ink jet recording methods and recording can be carried out even to a recording medium having no quick-drying property and ink absorptivity other than a specific paper. Accordingly, attention has been given to the photo curable type ink jet recording method.

Generally, an ultraviolet ray (UV) light source is disposed in the ink jet printer of the photo curable type ink jet method. The UV light source irradiates ink jetted on the recording medium with UV-rays, so that radicals are formed to polymerize monomers or oligomers of ink compositions. Thus, the ink is immediately cured (see, for example, Japanese Application Patent Laid-Open Publication No. 2001-310454). However, when radical polymerization ink is used as ink for recording, it is required to irradiate with UV-rays of high illumination, so that the UV-ray light source tends to become large. Accordingly, the ink jet printer itself becomes large, thereby raising the cost for the ink jet printer.

Recently, cationic polymerization ink which is cured by UV-rays of low illumination in comparison to the radical polymerization ink has been developed and put in practical use. When the cationic polymerization ink is used as the ink for recording, the ink can be cured by UV-rays with low illumination. Thus, the UV-ray light source can be minimized, thereby minimizing the ink jet printer itself. Moreover, when using a recording medium such as a shrink film or the like having no ink absorptivity, it can be suppressed that the recording medium shrinks after UV-ray irradiation. However, in the above cationic polymerization ink, a property change by the environment is large. Specially, since a curing property is dependent upon the humidity and temperature, upon producing printings, the ink may not be cured enough even irradiating with UV-rays because of the humidity and temperature in the environment.

### SUMMARY OF THE INVENTION

An object of the present invention is to provide a liquid jetting apparatus which can cure liquid of photo curable type such as the above ink or the like without being affected by the humidity and temperature in the environment.

In the first aspect of the invention, the liquid jetting apparatus comprises:

a head for jetting a liquid of photo curable type which is cured by an irradiation with light;

a light source for irradiating the liquid of photo curable type jetted on an object from the head;

at least one of a temperature sensor for detecting a temperature adjacent to the object, and a humidity sensor for detecting a humidity adjacent to the object; and

a control section for controlling an illumination of light which is radiated from the light source,

wherein the control section controls the illumination on the basis of a result detected by at least one of the temperature sensor and the humidity sensor.

According to the liquid jetting apparatus, since the control section controls the illumination of light on the basis of the result detected by at least one of the temperature sensor and the humidity sensor, the illumination of light from the light source can be controlled according to the environmental change of at least one of the temperature and the humidity adjacent to the object. Thus, the liquid of photo curable type can be cured without being affected by the temperature and the humidity in the environment. Moreover, since there is no need to radiate light to the object to make the illumination be not less than necessary to cure the ink, the electricity for turning on the light source can be suppressed, thereby extending the life of the light source.

In the liquid jetting apparatus, the control section may store a relationship between at least one of a temperature and a humidity, and a liquid cure necessary illumination value of light necessary for curing the liquid corresponding to at least one of a humidity and a temperature as a first data table,

the control section specifying the liquid cure necessary illumination value from the first data table on the basis of the result to control the illumination for turning the light source on to make the illumination be not less than the liquid cure necessary illumination value.

According to the liquid jetting apparatus, at least one of the temperature and the humidity, and liquid cure necessary illumination values corresponding thereto are pre-stored in the control section as the first data table. The control section specifies the liquid cure necessary illumination value from the first data table on the basis of the result detected by at least one of the temperature sensor and the humidity sensor, and controls the light source to turn on to make the illumination be not less than the liquid cure necessary illumination value. Accordingly, in the liquid jetting apparatus, the light source turns on to make the illumination be not less than the liquid cure necessary illumination value corresponding to at least one of the temperature and the humidity to certainly cure the liquid of photo curable type without being affected by the temperature and the humidity in the environment.

The liquid jetting apparatus may further comprise an illumination detection sensor for detecting the illumination,

wherein the control section may store a second data table in which an illumination value obtained by irradiation with light radiated from the light source is divided into a plurality of illumination levels, and

the control section may rewrite illumination values corresponding to each of the illumination levels in the second data table on the basis of a result detected by the illumination detection sensor, select an illumination level having an illumination value not less than the liquid cure necessary illumination value, and control the illumination for turning the light source on to make the illumination be the illumination value of the illumination level selected.

According to the liquid jetting apparatus, the plurality of illumination levels and the illumination values corresponding to each of the illumination levels are stored in the control section as the second data table, the control section rewrites the illumination values obtained by irradiation with light corresponding to each of the illumination levels in the second data table according to-the result detected by the illumination detection sensor, selects the illumination level having the illumination value more than the liquid cure necessary illumination value, and controls the light source to turn on to make the illumination be the illumination value of the illumination level selected. That is, even when the illumination of light lowered according to the frequency of use, the illumination values in the second data table are accordingly rewritten. An illumination level having an illumination value not less than the liquid cure necessary illumination value is selected from the rewritten second data table, and the light source turns on to make the illumination be the illumination value of the illumination level selected. Accordingly, in the liquid jetting apparatus, even when the illumination of light lowered according to the frequency of use, the light source always turns on to make the illumination be not less than the liquid cure necessary illumination value to certainly cure the liquid of photo curable type.

The liquid jetting apparatus may comprise a plurality of light sources, and

the control section may judge whether the liquid cure necessary illumination value exceeds an upper limit of the illumination value obtained by irradiation with light radiated from the light source, and when the control section judges that the liquid cure necessary illumination value specified exceeds the upper limit, the control section may turn on the other light source different from the light source to make a total value of illuminations of light from the light source and the other light source exceed the liquid cure necessary illumination value.

According to the liquid jetting apparatus, when the liquid cure necessary illumination value exceeds the upper limit of the illumination value obtained by irradiation from the light source, the other light source turns on. Thus, even when the liquid cannot be cured only by the illumination of light from the light source because of the degradation of the illumination or the like by the environmental change of the temperature and humidity, a long-term use of the light source or the like, the liquid of photo curable type can be cured.

The liquid jetting apparatus may further comprise a spare light source other than the light source for irradiating the liquid jetted on the object from the head with light,

wherein the control section may judge whether the liquid cure necessary illumination value exceeds an upper limit of the illumination value obtained by irradiation with light radiated from the light source, and when the control section judges that the liquid cure necessary illumination value specified exceeds the upper limit, the control section may control the spare light source to turn on.

According to the liquid jetting apparatus, when the liquid cure necessary illumination exceeds the upper limit of the illumination value, the spare light source turns on. Thus, even when the liquid cannot be cured only by the illumination of light from the light source because of the degradation of the illumination or the like by the environmental change of the temperature and humidity, a long-term use of the light source or the like, the liquid of photo curable type can be cured.

Preferably, in the liquid jetting apparatus, the liquid cure necessary illumination value rises as a humidity becomes high in the first data table.

According to the liquid jetting apparatus, the liquid cure necessary illumination value rises as humidity becomes high in the first data table, so that the illumination of light radiated from the light source rises as humidity becomes high. Thus, even when humidity dependent liquid which is difficult to be cured under the high-humidity environment is jetted from the head, the liquid of photo curable type can be certainly cured.

Preferably, in the liquid jetting apparatus, the liquid cure necessary illumination value corresponds to both a temperature and a humidity in the first data table.

According to the liquid jetting apparatus, since the liquid cure necessary illumination value corresponds to both temperature and humidity in the first data table, the liquid can be cured by the illumination of light which corresponds to both temperature and humidity.

Preferably, in the liquid jetting apparatus, the liquid cure necessary illumination value depends upon a type of the liquid.

According to the liquid jetting apparatus, since the liquid cure necessary illumination value depends upon the type of the liquid, each of a plurality type of liquids can be cured by illumination of light corresponding to each type.

Preferably, in the liquid jetting apparatus, the object comprises a recording medium, and the liquid comprises an ink having a color material as a composition.

According to the liquid jetting apparatus, image can be recorded on the recording medium as the object by jetting the ink as the liquid from the head.

Preferably, in the liquid jetting apparatus, the light comprises an ultraviolet ray, and the liquid comprises an ink which is cured by an irradiation with an ultraviolet ray.

According to the liquid jetting apparatus, the ink as the liquid can be cured by ultraviolet rays.

Preferably, in the liquid jetting apparatus, the liquid comprises a cationic polymerization ink containing a cationic polymerizing compound as a composition.

According to the liquid jetting apparatus, since the liquid comprises the cationic polymerization ink, the cationic polymerization ink as the liquid can be cured by ultraviolet-rays with low illumination.

### BRIEF DESCRIPTION OF THE DRAWINGS

The present invention will become more fully understood from the detailed description given hereinafter and the accompanying drawings which are given by way of illustration only, and thus are not intended as a definition of the limits of the present invention, and wherein;

FIG. 1 is a schematic perspective view showing an ink jet printer;

FIG. 2 is a plan view of a carriage;

FIG. 3 is a block diagram showing a configuration of a control system of an ink jet printer;

FIG. 4A is a data table showing illumination values of ultraviolet-rays necessary for curing each color of inks of Y, M, C, K corresponding to specific temperature (° C.) and humidity (%), and FIG. 4B is a data table showing illumination values of ultraviolet-rays obtained by irradiation by each line-shaped light source with respect to each illumination level ┌1┘-┌5┘; and

FIG. 5 is a plan view showing a modification of the carriage of FIG. 2.

### DETAILED DESCRIPTION OF THE PREFERRED EMBODIMENTS

Hereinafter, the preferred embodiments of the present invention will be described in detail by reference to the attached drawings. However, the present invention is not limited thereto.

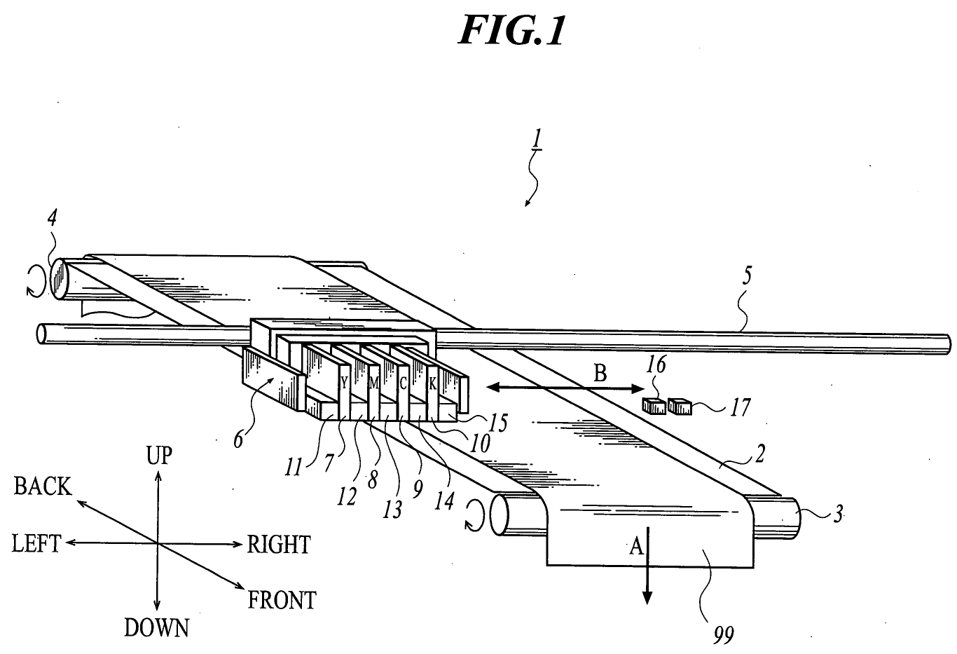

The configuration (including a configuration of a control system) of an ink jet printer 1 denoting the liquid jetting apparatus according to the present invention will be explained referring to FIGS. 1-3, 4A and 4B.

FIG. 1 is a schematic perspective view showing the ink jet printer 1.

As shown in FIG. 1, the ink jet printer 1 comprises a flat shape platen 2 for supporting a non-recording surface (the surface opposite to the recording surface) of the recording medium 99. Each of carrying rollers 3, 4 are disposed at back and front of the platen 2. Each of the carrying rollers 3, 4 are connected to carrying motors (not shown) for driving force, and is adapted to rotate at back and front of the platen 2 in a predetermined axis direction as each of the carrying motors drives. Therefore, the recording medium 99 are carried along a carrying direction A.

A long guide member 5 extends in a direction B (hereinafter, refer to “scanning direction B”) which is perpendicular to the carrying direction A over the platen 2. A carriage 6 is supported by the guide member 5. The carriage 6 is scannable (reciprocable) along the scanning direction B in a state of being guided and supported by the guide member 5.

The carriage 6 comprises four recording heads 7-10 for jetting each process color of inks of yellow (Y), magenta (M), cyan (c), black (B) therefrom to the recording medium 99, and five ultraviolet-ray (UV-ray) irradiation sections 11-15 for irradiating the recording medium 99 with UV-rays. In the carriage 6, the UV-ray irradiation sections 11-15 and the recording heads 7-10 are arranged alternately in the scanning direction B, providing irradiation sections on both sides of a recording head.

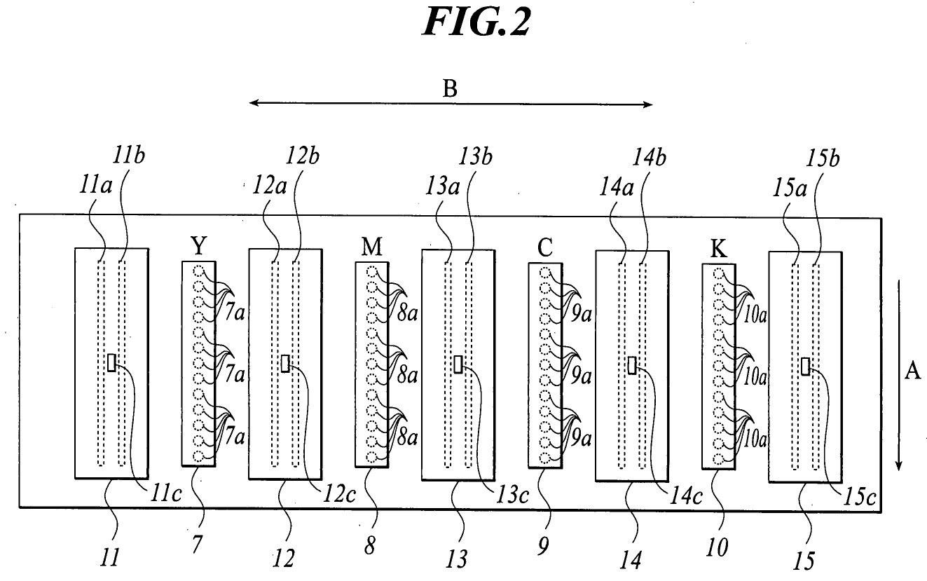

FIG. 2 is a plan view showing a detailed configuration of the carriage 6.

As shown in FIG. 2, a plurality of nozzles 7a, 7a, . . . ; 8a, 8a, . . . ; 9a, 9a, . . . ; 10a, 10a, . . . are disposed on each of the recording heads 7-11 in line along the carrying direction A. Each of the recording heads 7-11 is adapted to jet each color of ink of Y, M, C, K as fine droplets from the nozzles 7a, 7a, . . . ; 8a, 8a, . . . ; 9a, 9a, . . . ; 10a, 10a,. . . .

Two line-shaped light sources 11a, 11b; 12a, 12b; 13a, 13b; 14a, 14b; 15a, 15b are disposed on each of the UV-ray irradiation sections 11-15. Each of the UV-ray irradiation sections 11-15 is adapted to irradiate the recording surface of the recording medium 99 with UV-rays by turning on the line-shaped light sources 11a, 11b; 12a, 12b; 13a, 13b; 14a, 14b; 15a, 15b. As the line-shaped light sources 11a, 11b; 12a, 12b; 13a, 13b; 14a, 14b; 15a, 15b, a high pressure mercury lamp, metal halide lamp, black light, cold-cathode tube, LED (Light Emitting Diode) or the like can be employed. Illumination detection sensors 11c-15c for detecting illumination of UV-rays radiated from the line-shaped light sources 11a, 11b; 12a, 12b; 13a, 13b; 14a, 14b; 15a, 15b are disposed on each of the UV-ray irradiation sections 11-15.

In the two line-shaped light sources 11a, 11b; 12a, 12b; 13a, 13b; 14a, 14b; 15a, 15b, one of the line-shaped light sources 11a, 12a, 13a, 14a, 15a are used as light sources for recording in normal cases, and the other line-shaped light sources 11b, 12b, 13b, 14b, 15b are spare light sources used in an emergency.

The carriage 6 shown in FIG. 1 is movable to a position of the right side in FIG. 1 which is out of the position facing the platen 2 (hereinafter refer to “home LIQUID JETTING APPARATUS position”). When the ink jet printer 1 is not carrying out recording, the carriage 6 is on standby in the home position for the recording operation. In the home position, a temperature sensor 16 and a humidity sensor 17 are disposed, so that the temperature and the humidity adjacent to the recording medium 99 supported by the platen 2 can be detected.

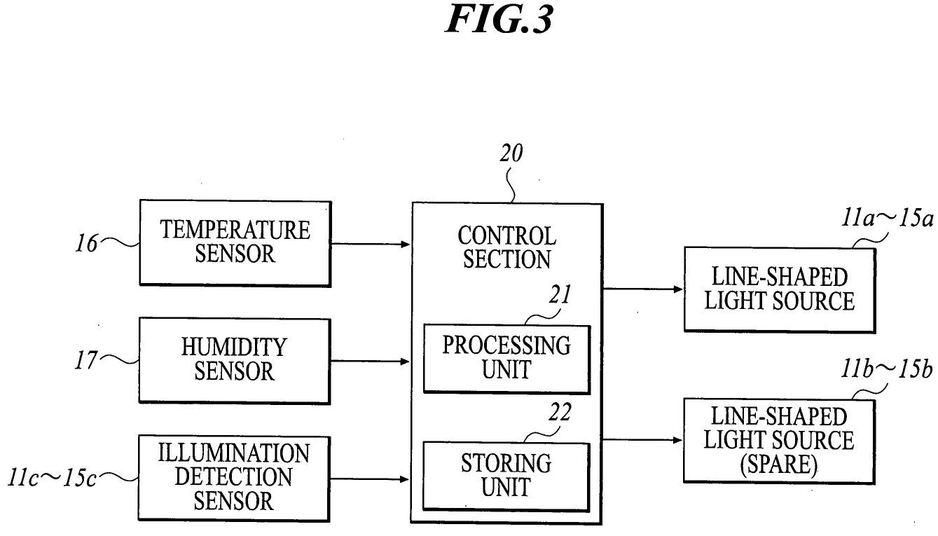

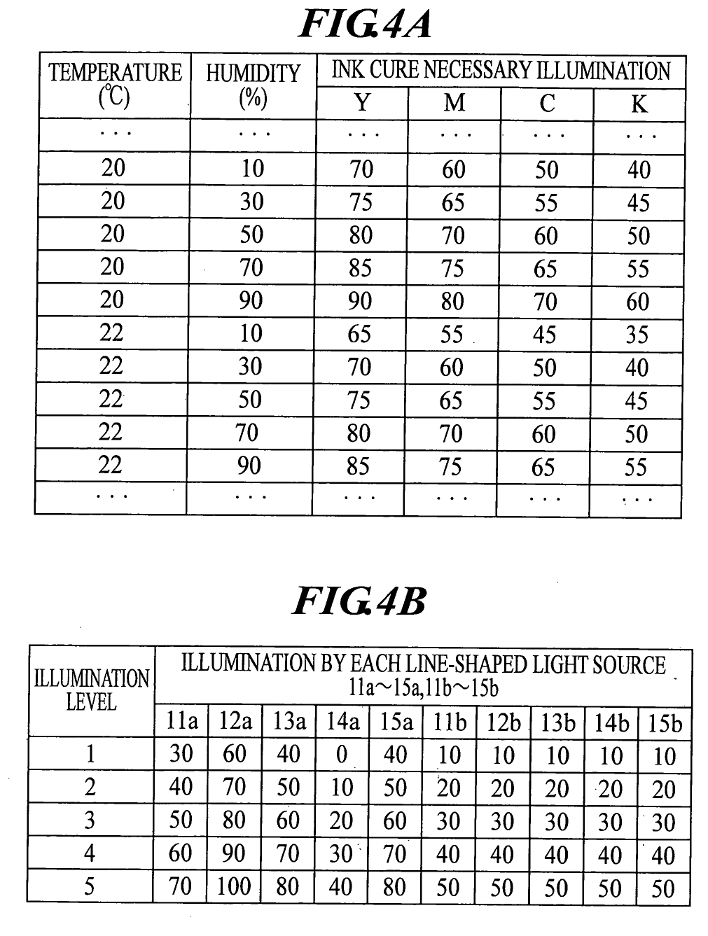

FIG. 3 is a block diagram showing a configuration of a control system of the ink jet printer 1, and FIGS. 4A and 4B are data tables stored in the control section for controlling the ink jet printer 1.

As shown in FIG.3, each of the temperature sensor 16, the humidity sensor 17, the illumination detection sensors 11c-15c, and the line-shaped light sources 11a-15a, 11b-15b are connected to the control section 20 for controlling the operation of each section of the ink jet printer 1. The control section 20 controls illumination of each line-shaped light source 11a-15a, 11b-15b on the basis of the result detected by each of the temperature sensor 16, humidity sensor 17, and the illumination detection sensors 11c-15c.

The control section 20 is provided with a processing unit 21 for computing various types of datum on the basis of the control program to output the control signals to each section, and a storing unit for storing the control program and the various types of datum. Specially, in the embodiment, each of the data tables shown in FIG. 4A and FIG. 4B are stored in the storing unit 22.

The first data table shown in FIG. 4A shows illumination values of UV-rays necessary for curing each color of inks of Y, M, C, K corresponding to a specific temperature (° C.) and humidity (%). In the data table shown in FIG. 4A, the illumination values of UV-rays necessary for curing each color of inks of Y, M, C, K rise as the humidity becomes high. The illumination values of UV-rays for curing each color of inks of Y, M, C, K are set to be optimal illumination values corresponding to the type of ink thereof. The second data table shown in FIG. 4B shows illuminations values of UV-rays obtained by irradiation by each of the line-shaped light sources 11a-15a, 11b- 15b corresponding to the illumination levels ┌1┘- ┌5┘.

The ink used in the embodiment will be explained.

As the ink used in the embodiment, specially, the ink adapted in “Curing System Utilizing Photo-Acid and Base Generating Agent (Section 1)” or “Photo-induced Alternating Copolymerization (Section 2)” of “Photo-Curing System (Chapter 4)” in “Photo-Curing Technique-Selection and Compounding Condition of Resin and Initiator, and Measurement and Assessment of Curing Degree (Technical Association Information)” can be applied. The ink which is cured by radical polymerization may be also used.

Specifically, the ink used in the embodiment is photo curable ink having a property of being cured by the irradiation with UV-rays as light. As the main component of the ink, at least polymerizing compound (publicly known polymerizing compounds are included.), photo initiator and color material are included. However, when the ink which is adapted to the above described “Photo-Induced Alternating Copolymerization (Section 2)” is used in the embodiment, the photo initiator may be excluded.

The above described photo curable ink is classified into radical polymerization ink containing radical polymerizing compound and cationic polymerization ink containing cationic polymerizing compound, and both of them are adaptable as the ink to be used in the embodiment. Hybrid ink in which the radical polymerization ink and the cationic polymerization ink are combined may also be applied.

The recording medium 99 used in the embodiment will be explained.

As the recording medium 99 used in the embodiment, the recording medium which comprises a material such as various types of papers including a plain paper, a recycled paper and a gloss paper, textiles, non-woven fabrics, resin, metal and glass or the like can be applied. As a form of the recording medium 99, a roll type, a cut sheet type, a plate type or the like can be applied. In the embodiment, a long resin made film which is wound in a roll state is used.

An operation of the ink jet printer 1 will be explained.

During the recording operation of the ink jet printer 1 shown in FIG. 1, the carrying motors connected to each of the carrying rollers 3, 4 are driven, and the carrying rollers 3, 4 repeat a given amount of rotation and a stop. The recording medium 99 intermittently moves from back to forth on the platen 2 in a state of being supported on the non-recording surface by the platen 2. Every time each of the rollers 3, 4 stops, the carriage 6 operates to move from right to left or left to right in FIG. 1 along the scanning direction B over the recording medium 99. The four recording heads 7-10 and the five UV-ray irradiation sections 11-15 mounted on the carriage 6 are also move along the scanning direction B over the recording medium 99 together with the carriage 6.

For the convenience sake, in the following explanations, the movement of the carriage 6 from right to left in FIG. 1 denotes “forward movement”, and the movement of the carriage 6 from left to right in FIG. 1 denotes “return movement”.

Each of the recording heads 7-10 jets ink from the nozzles 7a, 7a, . . . ; 8a, 8a, . . . ; 9a, 9a, . . . ; 10a, 10a, . . . toward the recording surface of the recording medium 99 while carrying out the forward-and-return movements of the carriage 6.

When the carriage 6 is carrying out the forward movement, the line-shaped light sources 12a-15a positioned on the back side of each of the recording heads 7-10 in the moving direction of the carriage 6 turn on to irradiate the ink which has just jetted on the recording medium 99 with UV-rays. The ink is cured and fixed on the recording surface of the recording medium 99. When the carriage 6 is carrying out the return movement, the line-shaped light sources 11a-14a positioned on the back side of each of the recording heads 7-10 in the moving direction of the carriage 6 turn on to irradiate the ink which has just jetted on the recording medium 99 with UV-rays. The ink is cured and fixed on the recording surface of the recording medium 99.

In the embodiment, during the recording operation of the ink jet printer 1, the control section 20 controls illumination of each of the line-shaped light sources 11a-15a, 11b-15b by using each of the data table shown in FIG. 4A and 4B on the basis of the results detected by each of the temperature sensor 16 and the humidity sensor 17.

Specifically, explanation will be given wherein the carriage 6 carries out the forward movement. For example, when the temperature detected by the temperature sensor 16 is 22° C. and the humidity detected by the humidity sensor 17 is 30%, the processing unit 21 of the control section 20 specifies the illumination value of UV-rays necessary for curing ink corresponding to the temperature of 22° C. and the humidity of 30% for each color of Y, M, C, K on the basis of the data table in FIG. 4A stored in the control section 20, and reads them. Thus, the processing unit 21 recognizes that the illumination value of UV-rays necessary for curing the ink of Y is ┌70┘. In the same way, the processing unit 21 recognizes that the illumination values of UV-rays necessary for curing each of the inks of M, C, Y are ┌60┘, ┌50┘, ┌40┘.

In the four line-shaped light sources 12a-15a used during the forward movement of the carriage 6, the processing unit 21 selects the illumination levels having the illumination not less than the illumination value necessary for curing each color of inks of Y, M, C, K for each of the line-shaped light sources 12a-15a from the data table in FIG. 4B stored in the storing unit 22.

That is, when the carriage 6 is carrying out the forward movement, the ink of Y jetted from the nozzles 7a of the recording head 7 is irradiated with UV-rays by turning on the line-shaped light source 12a and is cured. Thus, the illumination level corresponding to the line-shaped light source 12a is selected for the illumination level of UV-rays for curing the ink of Y. In the same way, each of the illumination levels corresponding to the line-shaped light sources 13a, 14a, 15a is selected for the illumination levels of UV-rays for curing the inks of M, C, K.

Accordingly, as described above, since the illumination value of UV-rays necessary for curing the ink of Y is ┌70┘, the processing unit 21 selects the illumination level ┌2┘ for the line-shaped light source 12a. In the same way, the processing unit 21 selects the illumination level of ┌3┘ for the line-shaped light source 13a and the illumination level of ┌1┘ for the line-shaped light source 15a.

The processing unit 21 judges whether the illumination values necessary for curing ink specified on the basis of the results detected by the temperature sensor 16 and the humidity sensor 17 exceed the upper limits of the illumination values obtained by the irradiation by each of the line-shaped light sources 12a-15a to select the illumination level for each of the line-shaped light sources 12a-15a. However, even though UV-rays having illumination of ┌50┘ is required for curing the ink of C under the condition of the temperature of 22° C. and the humidity of 30% as described above, the upper limit of illumination value obtained by the irradiation by the line-shaped light source 14a (┌40┘) is less than ┌50┘. In this case, the processing unit 21 selects the maximum illumination level of ┌5┘ for the line-shaped light source 14a and also, selects the illumination level for the spare line-shaped light source 14b for supplementing the amount of illumination (┌10┘) which cannot be fulfilled by the illumination of UV-rays by the line-shaped light source 14a. The processing unit 21 selects the illumination level of ┌1┘ for the line-shaped light source 14b.

The processing unit 21 reads out the illumination levels for the line-shaped light sources 12a, 13a, 14a, 15a from the data table in FIG. 4B, and outputs the control signals to turn on each of the line-shaped light sources 12a, 13a, 14a, 15a at the illumination levels which were read out for each of them. Therefore, each of the line-shaped light sources 12a, 13a, 14a, 15a turns on corresponding to each illumination level so as to make the UV-ray irradiation sections 12-15 irradiate each color of inks of Y, M, C, K jetted on the recording medium 99 with UV-rays of a predetermined illumination.

In the ink jet printer 1, the above described operations are repeated while accordingly selecting the illumination levels for the line-shaped light sources 11a-15a, 11b-15b during the forward and return movements of the carriage 6 to record a predetermined image in order on the recording surface of the recording medium 99 which passes above the platen 2.

The illumination of each of the line-shaped light sources 11a-15a, 11b-15b lowers according to frequency of use. Thus, when the ink jet printer 1 is started, or every time a predetermined number of images are recorded or a predetermined time passes during the operation of the ink jet printer 1, each of the illumination detection sensors 11c-15c of the UV-ray irradiation sections 11-15 detects the illumination of each of the line-shaped light sources 11a-15a, 11b-15b, and the processing unit 21 of the control section 20 accordingly rewrites the illumination values obtained by each of the line-shaped light sources 11a-15a, 11b-15b in the data table shown in FIG. 4B stored in the storing unit 22 on the basis of the results detected by each of the illumination detection sensors 11c-15c. Therefore, the illumination values obtained by each of the line-shaped light sources 11a-15a, 11b-15b are regularly renewed, and the illumination levels of UV-rays for curing each color of inks of Y, M, C, K are always maintained in high reliability. Even if the illumination of each of the line-shaped light sources 11a-15a, 11b-15b lowers according to frequency of usage, each of the line-shaped light sources 11a-15a, 11b-15b always turns on to make the illumination be not less than the illumination value necessary for curing to certainly cure the ink.

In the above described ink jet printer 1, the data table in FIG. 4A showing the ink cure necessary illumination values corresponding to the temperature and the humidity, and the data table in FIG. 4B in which the illumination values obtained by the irradiation by each of the line-shaped light sources 11a-15a, 11b-15b are divided into a plurality of illumination levels, are pre-stored in the storing unit 22 of the control section 20. The processing unit 21 of the control section 20 specifies the ink cure necessary illumination value for each color of inks from the data table in FIG. 4A based on the results detected by the temperature sensor 16 and the humidity sensor 17, selects the illumination level having the illumination more than the pre-specified ink cure necessary illumination value for each color of inks, and controls the illumination of light by each of the line-shaped light sources 11a-15a to turn on to make the illumination be each of the selected illumination levels.

Accordingly, in the ink jet printer 1, each of the line-shaped light sources 11a-15a turns on to make the illumination be not less than the ink cure necessary illumination value which corresponds to the temperature and the humidity adjacent to the recording medium 99, so that each color of inks of Y, M, C, K can be certainly cured without being affected by the temperature and the humidity. Moreover, for curing each color of ink, the recording medium 99 is not irradiated with light to make illumination be more than necessary, so that the electricity for turning on each of the line-shaped light sources 11a-15a can be suppressed, thereby extending the life of the line-shaped light sources 11a-15a.

In the ink jet printer 1, as the above described line-shaped light sources 14a, 14b wherein the explanation is given that the carriage 6 carries out the forward movement as an example, when the ink cure necessary illumination value of each line-shaped light source 11a-15a exceeds the upper limit of the illumination value obtained by irradiation by each line-shaped light source 11a-15a, the spare line-shaped light sources 11b-15b turn on. Thus, even when the ink cannot be cured by the illuminations of UV-rays by the line-shaped light sources 11a-15a because the illuminations of the line-shaped light sources 11a-15a lowered by the environmental change of the temperature and the humidity or a long-term use, the spare line-shaped light sources 11b-15b turn on to certainly cure the ink.

The preset invention is not limited to the above described embodiment, and it is to be understood that various kinds of improvements and changes of configurations may be made without departing from the spirit of the present invention.

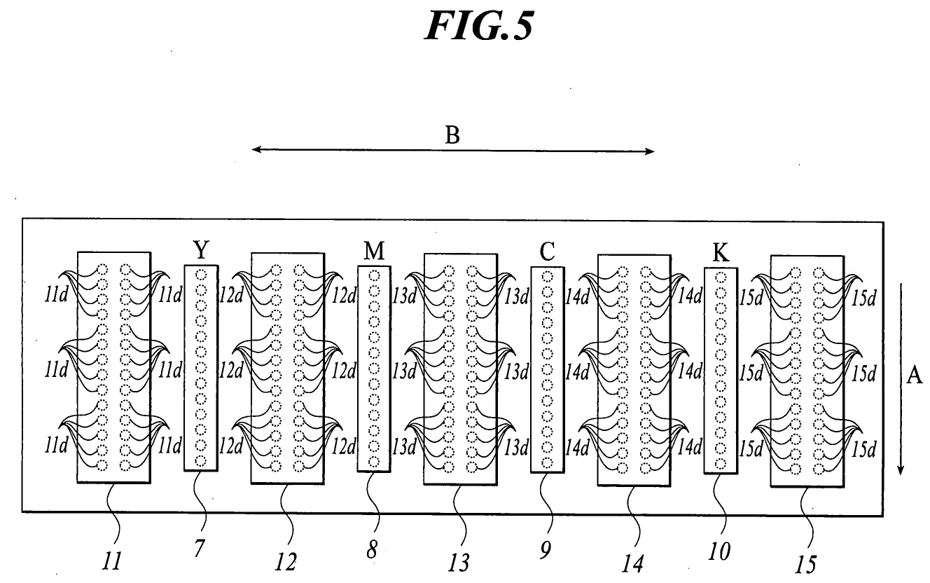

For example, in the above described embodiment, as shown in FIG. 2, the line-shaped light sources 11a-15a, 11b-15b are disposed on each of the UV-ray irradiation sections 11-15 corresponding thereto as an example, however, a plurality of dot-shaped light sources lid, 11d, . . . ; 12d, 12d, . . . ; 13d, 13d, . . . ; 14d, 14d, . . . ; 15d, 15d, . . . may be disposed to be arranged in one or more lines on every UV-ray irradiation section 11-15 as shown in FIG. 5 instead of the line-shaped light sources 11a-15a, 11b-15b. In this case, in the plurality of dot-shaped light sources 11d, 11d, . . . ; 12d, 12d, . . . ; 13d, 13d, . . . ; 14d, 14d, . . . ; 15d, 15d, . . . , some specific dot-shaped light sources are used as light sources for recording in normal cases, and the other dot-shaped light sources are used as spare light sources for an emergency.

In the above embodiment, it is explained that the spare line-shaped light sources 11b-15b turn on when the ink cure necessary illumination value shown in the data table in FIG. 4A exceeds the upper limit of the illumination value in the data table in FIG. 4B. However, when the ink cure necessary illumination value in FIG. 4A exceeds the upper limit of the illumination value shown in FIG. 4B, the insufficient illumination of UV-rays in the illumination of UV-rays by the line-shaped light sources 11a-15a may be supplemented by other line-shaped light sources that are for curing inks with colors different from that of the target ink to be cured without turning on the spare line-shaped light sources 11b-15b.

An explanation will be given by employing the case explained in the above embodiment as an example (the case where the carriage 6 carries out the forward movement, the temperature detected by the temperature sensor 16 is 22° C., and the humidity detected by the humidity sensor 17 is 30%). For supplementing the insufficient illumination of UV-rays by the line-shaped light source 14a (┌10┘), the processing unit 21 of the control section 20 may not select the illumination level ┌1┘ for the line-shaped light source 15a but select the illumination level ┌2┘ in which illumination ┌10┘ is added to the illumination level ┌1┘ in the data table in FIG. 4B.

In case of disposing the dot-shaped light sources 11d, 11d, . . . ; 12d, 12d, . . . ; 13d, 13d, . . . ; 14d, 14d, . . . ; 15d, 15d, . . . in FIG. 5 instead of the line-shaped light sources 11a-15a, 11b-15b in FIG. 2, as described above, the insufficient illumination of UV-rays in the illuminations of UV-rays by the dot-shaped light sources 11d, 11d, . . . ; 12d, 12d, . . . ; 13d, 13d, . . . ; 14d, 14d, . . . ; 15d, 15d, . . . may be supplemented by other dot-shaped light sources that are for curing inks with colors which are different from that of the target ink to be cured.

In the embodiment, photo-curable ink which is cured by irradiation with UV-rays (including radical polymerization ink, cationic polymerization ink, and hybrid ink) is exemplified, however it is not limited thereto. The ink employed in the embodiment may be the ink which is cured by irradiation with light other than UV-rays. The “light” is light in a broad sense which includes electromagnetic waves such as ultraviolet-rays (UV-rays), electron beam, X-rays, visible rays, infrared rays and the like. That is, polymerizing compound which is polymerized by light other than UV-rays to be cured and photo initiator for initiating polymerization reaction between polymerizing compounds by light other than UV-rays may also be applied in the ink used in the embodiment. When photo curable ink which is cured by light other than UV-rays is applied as the ink to be used in the embodiment, the line-shaped or dot-shaped light sources which can irradiate with light other than UV-rays are required to be applied instead of the line-shaped light sources 11a-15a, 11b-15b shown in FIG. 2, or the dot-shaped light sources 11d, 11d, . . . ; 12d, 12d, . . . ; 13d, 13d, . . . ; 14d, 14d, . . . ; 15d, 15d, . . . shown in FIG. 5.

In the embodiment, the example is given where the liquid jetting apparatus according to the present invention is applied to the ink jet printer 1, and the ink is jetted from the recording heads 7-10 to record image on the recording medium 99. However, in the liquid jetting apparatus for jetting liquid from heads to an object, liquid which contains conductive particles may be applied as the liquid, and a substrate may be applied as the object. In this case, the liquid containing conductive particles is jetted from the heads to the substrate to form a conducting wire or an electrode layer having a predetermined pattern on the substrate. Contrary to this, etching solution may be applied as the liquid, and a substrate on which a metal layer is pre-formed may also be applied as the object. In this case, the etching solution is jetted from the heads on the substrate on which the metal layer is formed to form a conducting wire or an electrode layer having a predetermined pattern.

The entire disclosure of Japanese Patent Application No. Tokugan 2003-009049 which was filed on Jan. 17, 2003, including specification, claims, drawings and summary are incorporated herein by reference in its entirety.

What is claimed is:

1. A liquid jetting apparatus comprising:
a head for jetting a liquid of photo curable type which is cured by an irradiation with light;
a light source for irradiating the liquid of photo curable type jetted on an object from the head;
at least one of a temperature sensor for detecting a temperature adjacent to the object, and a humidity sensor for detecting a humidity adjacent to the object; and
a control section for controlling an illumination of light which is radiated from the light source,
wherein the control section controls the illumination on the basis of a result detected by at least one of the temperature sensor and the humidity sensor.

2. The liquid jetting apparatus of claim 1, wherein the control section stores a relationship between at least one of a temperature and a humidity, and a liquid cure necessary illumination value of light necessary for curing the liquid corresponding to at least one of a humidity and a temperature as a first data table,
the control section specifying the liquid cure necessary illumination value from the first data table on the basis of the result to control the illumination for turning the light source on to make the illumination be not less than the liquid cure necessary illumination value.

3. The liquid jetting apparatus of claim 2, further comprising an illumination detection sensor for detecting the illumination,
wherein the control section stores a second data table in which an illumination value obtained by irradiation with light radiated from the light source is divided into a plurality of illumination levels, and
the control section rewrites illumination values corresponding to each of the illumination levels in the second data table on the basis of a result detected by the illumination detection sensor, selects an illumination level having an illumination value not less than the liquid cure necessary illumination value, and controls the illumination for turning the light source on to make the illumination be the illumination value of the illumination level selected.

4. The ink jet recording apparatus of claim 2, wherein the liquid jetting apparatus comprises a plurality of light sources, and
the control section judges whether the liquid cure necessary illumination value exceeds an upper limit of the illumination value obtained by irradiation with light radiated from the light source, and when the control section judges that the liquid cure necessary illumination value specified exceeds the upper limit, the control section turns on the other light source different from the light source to make a total value of illuminations of light from the light source and the other light source exceed the liquid cure necessary illumination value.

5. The liquid jetting apparatus of claim 2, further comprising a spare light source other than the light source for irradiating the liquid jetted on the object from the head with light,
wherein the control section judges whether the liquid cure necessary illumination value exceeds an upper limit of the illumination value obtained by irradiation with light radiated from the light source, and when the control section judges that the liquid cure necessary illumination value specified exceeds the upper limit, the control section controls the spare light source to turn on.

6. The liquid jetting apparatus of claim 2, wherein the liquid cure necessary illumination value rises as a humidity becomes high in the first data table.

7. The liquid jetting apparatus of claim 2, wherein the liquid cure necessary illumination value corresponds to both a temperature and a humidity in the first data table.

8. The liquid jetting apparatus of claim 2, wherein the liquid cure necessary illumination value depends upon a type of the liquid in the first data table.

9. The liquid jetting apparatus of claim 1, the object comprises a recording medium, and the liquid comprises an ink having a color material as a composition.

10. The liquid jetting apparatus of claim 1, the light comprises an ultraviolet ray, and the liquid comprises an ink which is cured by an irradiation with an ultraviolet ray.

11. The liquid jetting apparatus of claim 10, the liquid comprises a cationic polymerization ink containing a cationic polymerizing compound as a composition.
